(19) United States
(12) Patent Application Publication
(10) Pub. No.: US 2003/0170030 A1
(43) Pub. Date: Sep. 11, 2003

(54) Optical delay unit

(76) Inventors: Masashi Usami, Saitama (JP); Kosuke Nishimura, Saitama (JP)

Correspondence Address: CHRISTIE, PARKER & HALE, LLP, P.O. BOX 7068, PASADENA, CA, 91109-7068, US

(21) Appl. No.: 10/361,536

(22) Filed: Feb. 10, 2003

(30) Foreign Application Priority Data
Mar. 8, 2002 (JP) 2002-063343

(51) Int. Cl. H04J 14/02

(52) U.S. Cl. 398/87; 398/161

(57) ABSTRACT

An optical delay unit comprises a periodic wavelength demultiplexer having M (M is a natural number) input ports including a signal input port, M output ports including a signal output port, and periodic input/output characteristics for wavelengths between the M input ports and the M output ports, and (M−1) optical paths to connect each of the (M−1) output ports in which the signal output port is excluded from the M output ports of the periodic wavelength demultiplexer with any of the (M−1) input ports in which the signal input port is excluded from the M input ports of the periodic wavelength demultiplexer.

As an optical delay unit capable of changing a delay time, a configuration has been proposed in which a loop of optical fiber and an optical switch are combined to circulate an optical data signal in the loop of optical fiber while the optical switch takes out the optical signal after a desired number of circulations. Assuming that one circulation of the loop is one unit, this configuration makes it possible to obtain a delay amount one or multiple times as much as the unit.

As an optical delay unit capable of changing a delay time, a configuration comprising a wavelength shifter in a loop of fiber to take out a signal having reached a predetermined wavelength from the loop with a wavelength selective filter has been proposed (e.g. T. Sakamoto et. al., “Variable optical delay circuit using wavelength converters”, Electron. Lett., vol. 37, pp. 454-455, 2001). By disposing a wavelength converter in front of this configuration to select wavelengths entering the loop, the number of circulations in the optical loop can be controlled.

Another well-known configuration is the one capable of adjusting propagation time, namely delay time, by disposing a wavelength converter on both side of a dispersion medium whose propagation time varies according to a wavelength in order to select a wavelength of an optical carrier propagating the dispersion medium.

A configuration also well known is the one comprising a plurality of optical paths whose propagation time are different from each other, a first wavelength converter to convert an optical carrier wavelength of an input signal light into an arbitrary wavelength, an optical router to apply the signal light from the wavelength converter to a predetermined optical path in a plurality of the optical paths according to the wavelength of the signal light, a multiplexer to multiplex the signal lights from the plurality of optical paths, and a second wavelength converter to convert the wavelength of the signal light from the multiplexer into the original wavelength (e.g. U.S. Pat. No. 5,367,586).

However, in the conventional configuration to control a number of circulations in a fiber loop using an optical switch, a controller becomes complicated because it needs to dynamically control the optical switch. Furthermore, the conventional configuration is unable to use an optical data signal longer than one cycle of a fiber loop because its data overlaps while circulating.

In the conventional configuration combining a wavelength converter and a dispersion medium, a range of delay time to be obtained is narrow. To obtain a longer delay time, it needs to use a longer dispersion medium and thus this configuration necessarily becomes large-sized.

In the conventional configuration combining a plurality of optical paths whose propagation time is different from each other, a wavelength converter, and optical router, each of the optical paths is practically realized with an optical fiber and thus this configuration also becomes large-sized.

It has been considered to use an optical circuit as the alternative of an electric circuit because of its high-speed performance. For such use, the optical circuit is desirable to be easily integrated and more preferably to be suitable for downsizing.

Also, in a wavelength division multiplexing system, if an optical delay unit having a delay amount depending on a wavelength is realized, WDM (wavelength-division-multiplex) signals (or parallel signals) are easily converted into TDM (time-division-multiplex) signals (or serial signals), for example.

### SUMMARY OF THE INVENTION

An optical delay unit according to the present invention comprises a periodic wavelength demultiplexer having M (M is a natural number) input ports including a signal input port, M output ports including a signal output port, and periodic input/output characteristics for wavelengths between the M input ports and the M output ports; and (M−1) optical paths to connect each of the (M−1) output ports in which the signal output port is excluded from the M output ports of the periodic wavelength demultiplexer with any of the (M−1) input ports in which the signal input port is extracted from the M input ports of the periodic wavelength demultiplexer.

In this configuration, a signal light entered any input port of the periodic wavelength demultiplexer transmits a different optical path according to its optical carrier wavelength. Owing to this operation, it is possible to predetermine a delay amount depending on a wavelength. Since a delay amount of each optical path can be set separately, a whole delay amount can be set in a wide range.

For instance, each of one or more optical paths in the (M−1) optical paths comprises an optical delay.

The optical delay unit according to the present invention further comprises a first wavelength converter to convert an optical carrier wavelength of input signal light into one of wavelengths capable of being demultiplexed by the periodic wavelength demultiplexer and apply to the signal input port. With this configuration, it is possible to delay an input signal light by a desired delay amount out of the wavelength-dependent delay amount in the periodic wavelength demultiplexer and the M optical paths.

The optical delay unit according to the present invention further comprises a second wavelength converter to convert an optical carrier wavelength of output signal light from the signal output port of the periodic wavelength demultiplexer into a predetermined wavelength. With this configuration, it is possible to set back or recover the optical carrier wavelength of signal light.

The optical delay unit according to the present invention further comprises a first wavelength converter to convert an optical carrier wavelength of a first input signal light into any one of wavelengths capable of being demultiplexed within a first free spectral range (FSR) of the periodic wavelength demultiplexer, a second wavelength converter to convert an optical carrier wavelength of a second input signal light into any one of wavelengths capable of being demultiplexed within a second FSR different from the first FSR of the periodic wavelength demultiplexer, an optical multiplexer to multiplex output signal lights from the first and second wavelength converters and apply to the signal input port, an optical demultiplexer to demultiplex output signal lights from the signal output port of the periodic wavelength demultiplexer into the signal light belonging to the first FSR and the signal light belonging to the second FSR, a third wavelength converter to convert the optical carrier wavelength of the signal light belonging to the first FSR demultiplexed by the optical demultiplexer into a first predetermined wavelength, and a fourth wavelength converter to convert the optical carrier wavelength of the signal light belonging to the second FSR demultiplexed by the optical demultiplexer into a second predetermined wavelength.

According to the above configuration, it is possible to delay two signal lights by a different delay amount respectively.

The optical delay unit according to the present invention further comprises an optical switch, to which a WDM optical signal inputs. The WDM optical signal is composed of a plurality of signal lights carried by optical carriers having of an AWG 10 where N=5;

FIG. 3 is a table showing circulation examples in the AWG 10 and a delay line 12 (12₁˜12_{N-2}) on condition that signal lights having wavelengths λ₁˜λ₄, entered an input port #1;

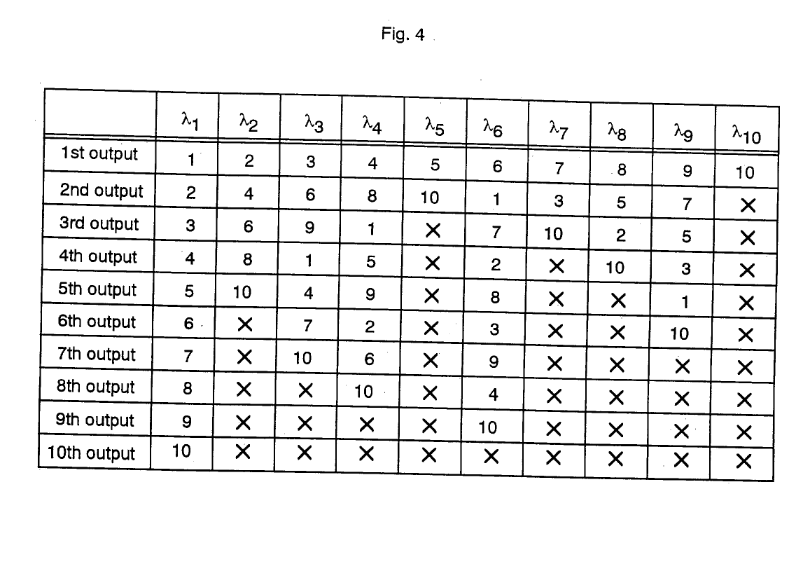

FIG. 4 is a table showing variation examples of an output port of each wavelength where N=11;

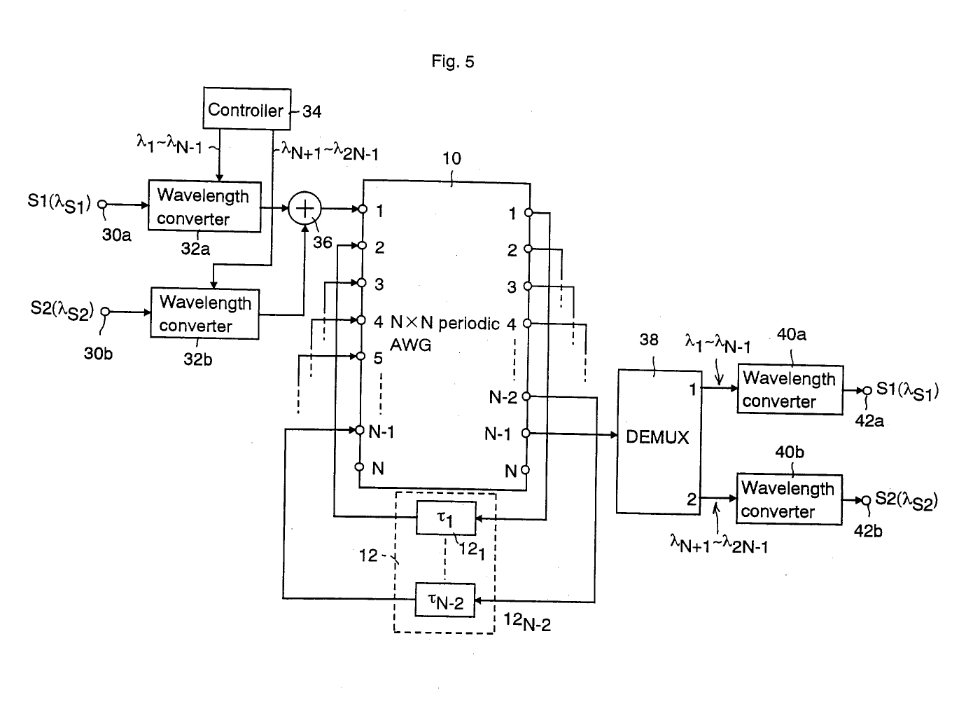

FIG. 5 shows a schematic block diagram of a second embodiment of the present invention;

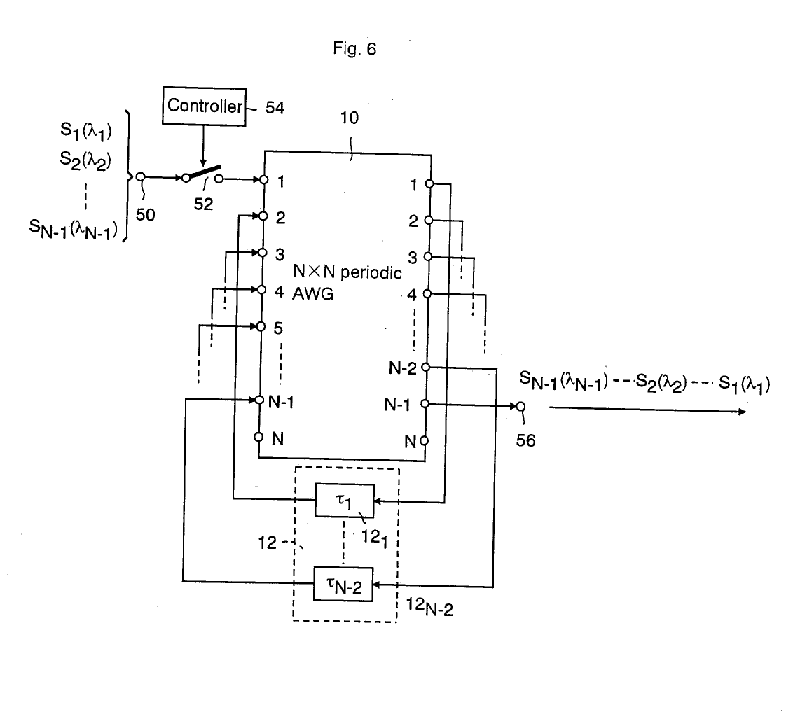

FIG. 6 shows a schematic block diagram of a third embodiment of the present invention;

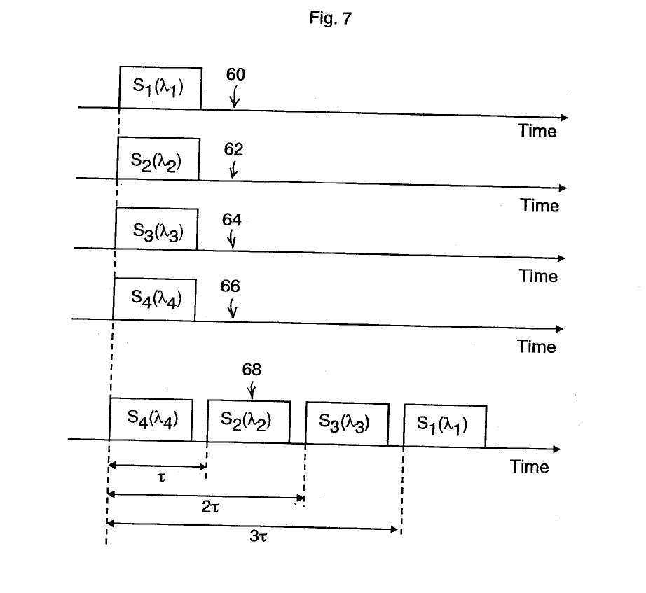

FIG. 7 shows a timing chart of the embodiment shown in FIG. 6;

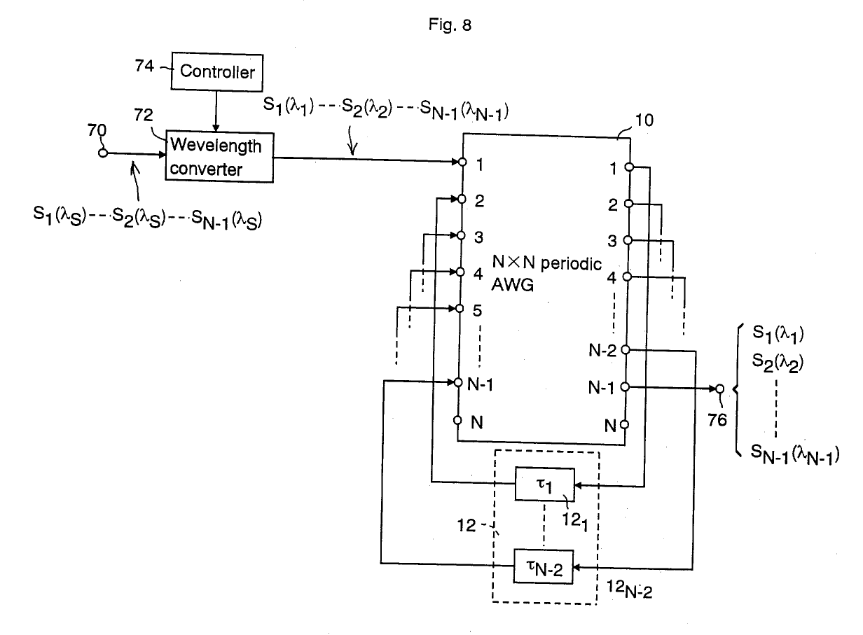

FIG. 8 shows a schematic block diagram of a fourth embodiment of the present invention; and

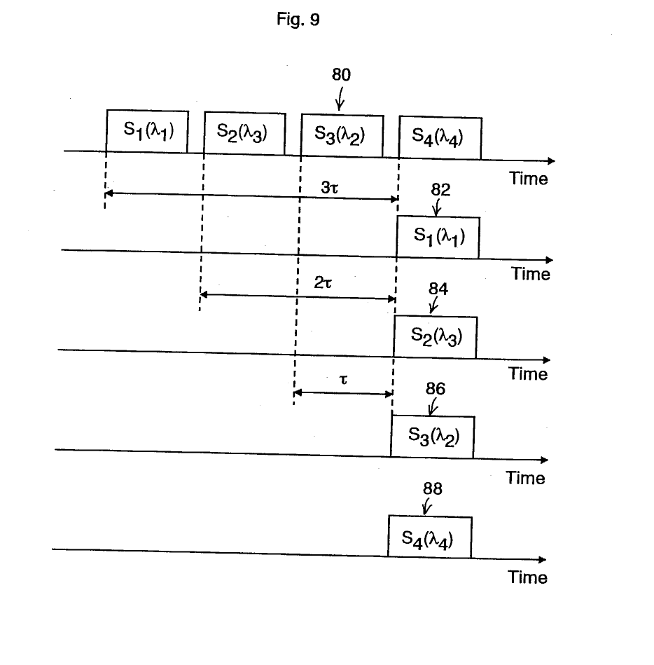

FIG. 9 shows a timing chart of the embodiment shown in FIG. 8.

### DETAILED DESCRIPTION

Embodiments of the invention are explained below in detail with reference to the drawings. In this specification, a symbol S(λ) expresses that a signal S is carried by an optical carrier having wavelength λ.

(A First Embodiment)

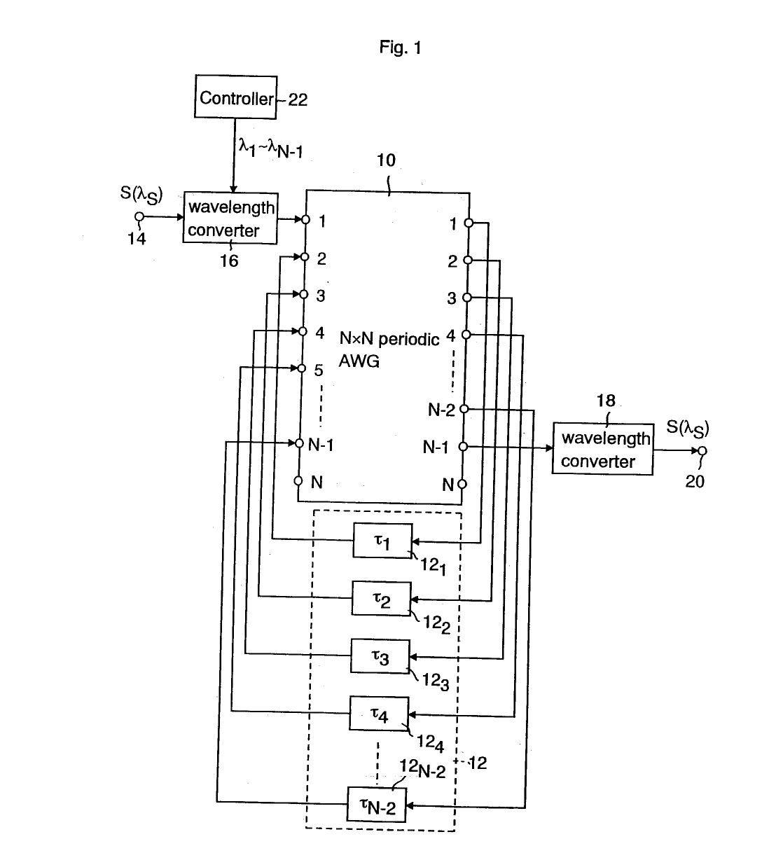

FIG. 1 shows a schematic block diagram of a first embodiment of the present invention. An arrayed waveguide grating (AWG) 10 comprises N input ports, N output ports, and periodic input/output characteristics. That is, when signal lights of wavelengths λ₁˜λ_{N} enter an input port #1, for example, the AWG 10 outputs a signal light of wavelength λ₁ from an output port #1, a signal light of wavelength λ₂ from an output port #2, and a signal light of wavelength λ_{N} from an output port #N. When the same signal lights enter an input port #2, the AWG 10 outputs a signal light of wavelength λ₁ from the output port #2, a signal light of wavelength λ₂ from an output port #3, a signal light of wavelength λ_{N-1} from the output port #N, and a signal light of wavelength λ_{N} from the output port #1. As explained above, the periodic AWG 10 comprises the input/output characteristics in which the corresponding relation between output ports and wavelengths periodically changes according to an input port number to which a signal light enters.

A delay line 12ᵢ of propagation time τᵢ connects between an output port #i and an input port #(i+1) of the AWG 10. The symbol i expresses an integer from 1 to (N−1). The propagation time τ₁˜τ_{N-2} of each the delay line 12₁˜12_{N-2} can be either identical or different.

For the purpose of the embodiment, the symbol N ideally should be a prime number. It is also applicable to connect the output port #(N−1) and the input port #N through a delay line and take out an optical delay signal from the output port #N. However, in this configuration, it is likely that the delay times of a plurality of wavelengths in the wavelengths λ₁˜λ_{N} happen to be identical. In a connecting configuration of the delay line 12 shown in FIG. 1, the delay amount of each wavelength λ₁˜λ₋₁ certainly differs from each other on condition that N is a prime number and the input port #N and output port #N are not used.

A signal light S (λₛ) enters a wavelength converter 16 through an input terminal 14. The wavelength converter 16 converts an optical carrier wavelength of the signal light S (λ_{S}) from λₛ to a predetermined wavelength within wavelengths λ₁˜λ_{N-1}. The output signal light from the wavelength converter 16 enters an input port #1 of an AWG 10. The output light from an output Port #(N−1) of the AWG 10 enters a wavelength converter 18. The output light from the wavelength converter 18 is sent to the outside through an output terminal 20. The wavelength converter 18, conversely to the wavelength converter 16, converts a wavelength of the signal light from the output port #(N−1) of the AWG 10 into a wavelength λₛ. A controller 22 controls to which wavelength the wavelength converter 16 converts.

The part composed of the AWG 10 and the delay line 12(12₁˜12_{N-2}) functions as an optical delay unit having a wavelength-dependent delay amount and thus firstly its operation is described below.

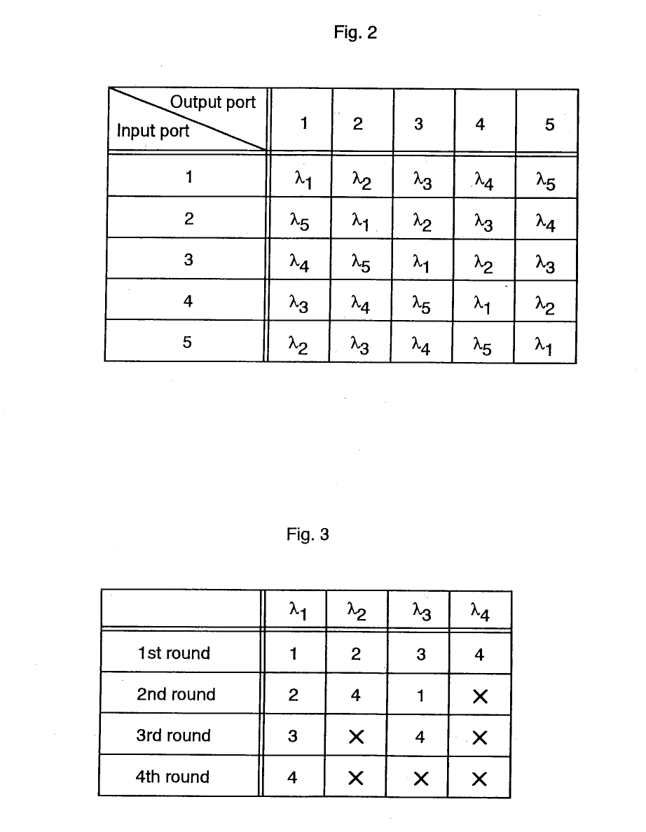

The delay time inside the AWG 10 is assumed to be expressed as τ₀. To make it clearly understandable, an example where N=5 is explained. FIG. 2 shows input/output characteristics of the AWG 10 where N=5. From FIG. 2, it is realized that an output port periodically changes according to the combination of a wavelength of input signal and an input port to which the signal entered.

FIG. 3 shows circulation examples in the AWG 10 and the delay line 12(12₁˜12_{N-2}) on condition that signal lights having wavelengths λ₁˜λ₄ entered the input port #1. FIG. 3 shows the output port number of each wavelength in each round.

As shown in FIG. 3, the signal light of wavelength λ₁is output from the output port #1 for the first round. The signal light of wavelength λ₁from the output port #1 enters the input port #2 through the delay line 12₁ and thus it is output from the output port #2 for the second round as shown in FIG. 2. The signal light of wavelength λ₁ from the output port #2 enters the input port #3 through the delay line 12₂ and thus it is output from the output port #3 for the third round as shown in FIG. 2. The signal light of wavelength λ₁ from the output port #3 enters the input port #4 through the delay line 12₃ and thus it is output from the output port #4 for the fourth round as shown in FIG. 2. As a result, the gross delay time of the signal light of wavelength λ₁ is expressed as (4τ₀+τ₁+τ₂+τ₃).

As shown in FIG. 3, the signal light of wavelength λ₂ is output from the output port #2 for the first round. The signal light of wavelength λ₂ from the output port #2 enters the input port #3 through the delay line 12₂ and thus it is output from the output port #4 for the second round as shown in FIG. 2. As a result, the gross delay time of the signal light of wavelength λ₂ is expressed as (2τ₀+τ₂).

As shown in FIG. 3, the signal light of wavelength λ₃ is output through the output port #3 for the first round. The signal light of wavelength λ₃ from the output port #3 enters the input port #4 through the delay line 12₃ and thus it is output from the output port #1 for the second round as shown in FIG. 2. The signal light of wavelength λ₃ from the output port #1 enters the input port #2 through the delay line 12₁ and thus it is output through the output port #4 for the third round as shown in FIG. 2. As a result, the gross delay time of the signal light of wavelength λ₃ is expressed as (3τ₀+τ₁+τ₃).

As shown in FIG. 3, the signal light of wavelength λ₄is output from the output port #4 for the first round. As a result, the delay time of the signal light of wavelength λ₄ is expressed as τ₀.

On condition that τ₁˜τ₃ are all equal to τand the delay time τ₀ inside the AWG 10 is negligibly smaller than τ, the relations between the wavelength and the delay time are expressed as follows:

The signal light of wavelength λ₁:3τ

The signal light of wavelength λ₂:τ

The signal light of wavelength λ₃:2τ

The signal light of wavelength λ₄:0

In other words, an optical delay unit having a delay time dependent on a wavelength is realized by connecting each output port with each input port under the condition that numbers of corresponding ports are deviated one by one and disposing the delay line 12 (12₁˜12_{N-2}) on each optical path connecting an output port and an input port. Furthermore, since the delay time depends on an optical path on which a signal light circulates and the delay time of one or more delay lines disposed on the optical path, a range of delay time can be easily extended.

In the embodiment shown in FIG. 1, when a delay amount of each delay line 12₁˜12_{N-2} is identical and assumed as 1 unit, it is possible to realize a delay amount of 0˜(N−2) times. On the other hand, when the delay amount of each delay line 12₁˜12_{N-2} is different, it is possible to select any of the delay amounts. For instance, on condition that the delay amounts of the delay lines 12₁˜12₃ are 1 unit, 2 unit, and 3 unit respectively where N=5, the delay amounts relative to the wavelengths are expressed as follows:

Wavelength λ₁:6 unit

Wavelength λ₂:2 unit

Wavelength λ₃:4 unit

Wavelength λ₄:0 unit

That is to say, it is possible to extend a dynamic range of delay amount.

For reference, transition examples of an output port in each wavelength where N=11 are shown in FIG. 4. In this case, the wavelength converter 18 is connected to the output port #10.

Similarly to the case where N=5, assumed that the delay time τ₁˜τ₉ of delay line 12 (12₁˜12₉) is identical to τ and the delay time τ₀ inside the AWG 10 is negligibly small compared to τ, the relations between the wavelength and delay time are expressed as follows:

The signal light of Wavelength λ₁:9τ

The signal light of Wavelength λ₂:4τ

The signal light of Wavelength λ₃:6τ

The signal light of Wavelength λ₄:7τ

The signal light of Wavelength λ₅:τ

The signal light of Wavelength λ₆:8τ

The signal light of Wavelength λ₇:2τ

The signal light of Wavelength λ₈:3τ

The signal light of Wavelength λ₉:5τ

The signal light of Wavelength λ₁₀:0

In the configuration shown in FIG. 1 in which an output port #i is connected to an input port #(i+1) whose port number is shifted by one, it is possible to differ a delay amount of each wavelength by ideally using the output port #(N−1) for an external output and setting N as a prime number. If the output port #N, for instance, is used for the external output, there is a possibility that a delay amount of a plurality of wavelengths becomes identical. However, as long as such a plurality of wavelengths are not used at the same time, there is no problem to use the other output ports besides the output port #(N−1) for the external output. For instance, it is applicable to connect the output port #1 with the wavelength converter 18. When the output port #1 is connected with the wavelength converter 18, wavelengths λ₂, λ₅, λ₇ and λ₈ are not output as shown in FIG. 4. However, by changing the connecting relation of the delay line 12, it can be changed. For example, a delay line to connect the output port #(N−1) with the input port #N and a delay line to connect the output port #N with the input port #1 should be added. Needless to say, when those wavelengths are not used, there is no need to add those delay lines.

When having a same delay amount in a plurality of wavelengths does not become a problem, either configuration is applicable; one is to connect the output port #i with an output port whose port number is shifted by two or more, and the other is to connect the output port #i with the input port #i having the same number. In short, each output port and each input port should be connected under a fixed regulation. Each delay amount is determined by a combination of an input port and an output port to be connected each other, a signal wavelength, an input port of the signal light, and an output port of the signal light.

A delay operation example of the embodiment shown in FIG. 1 where N=5 is explained below. The wavelength converter 16 converts the optical carrier wavelength λₛ of signal light S (λₛ) from the input terminal 14 into a wavelength within the wavelengths λ₁ ˜λ_{N-1} according to the instruction from the control circuit 22. Assuming that the wavelength converter 16 converts the wavelength λₛ to a wavelength λ₂, for instance. The signal light S (λ₂) of wavelength λ₂ from the wavelength converter 16 enters an input port #1 of the AWG 10. As already explained, the signal light S (λ₂) is delayed by the AWG 10 and the delay line 12 by τ(≅2τ₀+τ₂) and applied to the wavelength converter 18 through the port #(N−1) of the AWG 10. The wavelength converter 18 converts the optical carrier wavelength λ₂ of the signal S (λ₂) from the port #(N−1) of the AWG 10 into the original wavelength λₛ and outputs to the output terminal 20. When there is no need to set back the signal wavelength to the original wavelength λₛ, the wavelength converter 18 can be omitted.

Obviously from the above description, by selecting a wavelength to be converted by the wavelength converter 16 from the wavelengths λ₁,λ₂, λ₃, and λ₄, it is possible to select any one of delay amounts of 3τ(≅4τ₀+τ₁+τ₂+τ₃), τ(≅2τ₀+τ₂), 2τ(≅3τ₀+τ₁+τ₃), and 0(≅τ₀). In the embodiment shown in FIG. 1, since it is possible to select (N−1) wavelengths, a desirable delay amount is selectable from (N−1) delay amounts.

(A Second Embodiment)

A periodic AWG has characteristics wherein periodicity of the wavelengths λ₁˜λ_{N} is repeated under an FSR (Free Spectral Range) as its period on a wavelength axis. Therefore, the wavelengths λ₁˜λ_{N} of one FSR and the wavelengths λ_{N+1}˜λ_{2N} of the next FSR do not interfere with each other and propagate independently on the AWG 10 and the delay line 12. This means that a plurality of wavelength groups can share the delay unit comprised of the AWG 10 and the delay line 12. A schematic diagram of the embodiment is shown in FIG. 5. Elements identical to those in FIG. 1 are labeled with the common reference numerals. That is, the configuration of the AWG 10 and the delay line 12 is identical to that of the embodiment shown in FIG. 1.

A signal light S1 (λ_{S1}) of wavelength λ_{S1} enters an input terminal 30a and a signal light S2 (λ_{S2}) of wavelength λ_{S2} enters an input terminal 30b. The wavelengths λ_{S1} and λ_{S2} can be either equal or different. A wavelength converter 32a converts an optical carrier wavelength λ_{S1} of the signal light S1 (λ_{S1}) from the input terminal 30a into a wavelength λₐ which is any one of the wavelengths λ₁˜λ_{N-1} in a first FSR according to the instruction from a controller 34. Similarly, a wavelength converter 32b converts an optical carrier wavelength λ_{S2} of signal light S2 (λ_{S2}) from the input terminal 30b into a wavelength λ_{b} which is any one of the wavelengths λ_{N+1}˜λ_{2N-1} in a second FSR according to an instruction from the controller 34. A wavelength multiplexer 36 multiplexes the signal lights S1 (λₐ) and S2 (λ_{b}) from the wavelength converters 32a, 32b and applies to an input port #1 of the AWG 10.

On the AWG 10 and the delay line 12, the signal lights S1 (λₐ) and S2 (λ_{b}) propagate without interfering each other. The signal lights S1 (ₐ) and S2 (λ_{b}) are respectively delayed for a time determined according to respective wavelength and output from an output port #(N−1) of the AWG 10.

The output light from the output port #(N−1) of the AWG 10 enters a wavelength demultiplexer 38. The wavelength demultiplexer 38 demultiplexes the light from the output port #(N−1) of the AWG 10 into a wavelength band including wavelengths λ₁˜λ_{N-1} and a wavelength band including wavelengths λ_{N+1}˜λ_{2N-1} and applies the former to a wavelength converter 40a through the output port #1 and the latter to a wavelength converter 40b through an output port #2. With this operation, the signal light S1 (λₐ) enters the wavelength converter 40a and the signal light S2 (λ_{b}) enters the wavelength converter 40b.

The wavelength converter 40a converts the optical carrier wavelength λₐ of the signal light S1 (λₐ) from the wavelength demultiplexer 38 into the wavelength λₛ₁ and applies to an output terminal 42a. The wavelength converter 40b converts the optical carrier wavelength λ_{b} of the signal light S2 (λ_{b}) into the wavelength λₛ₂ and applies to an output terminal 42b.

(A Third Embodiment)

The AWG 10 and the delay line 12 can be used to demultiplex a WDM signal light into individual wavelengths and serializes them at a certain time interval. A schematic diagram of the embodiment is shown in FIG. 6.

The WDM signal lights S₁(λ₁)˜S_{N-1}(λ_{N-1}) of wavelengths λ₁˜λ_{N-1} enter an input terminal 50. A switch 52 turns ON for a certain period according to the instruction from a controller 54. With this operation, a certain timeslot portion is extracted from the signal lights S₁(λ₁)˜S_{N-1}(λ_{N-1}) from the input terminal 50. The signal lights S₁(λ₁)˜S_{N-1}(λ_{N-1}) having the timeslot extracted by the switch 52 enter an input port #1 of the AWG 10. As already explained, each of the signal lights S₁(λ₁)˜S_{N-1}) is delayed by the AWG 10 and the delay line 12 for a certain time according to its wavelength and sent to an output terminal 56 through an output port #(N−1). That is, each of the signal lights S₁(λ₁)˜S_{N-1}(λ_{N-1}) existing at the same time location in the input terminal 50 is rearranged at a different time location in the output terminal 56. This is so to say the conversion from a WDM (wavelength division multiplexing) signal to a TDM (time division multiplexing) signal.

Needless to say, it is necessary to appropriately set the delay time of each wavelength delayed by the AWG 10 and the delay line 12 and the turn-on-period of the switch 52 so that the signal lights S₁(λ₁)˜S_{N-1}(λ_{N-1}) extracted by the switch 52 do not overlapped each other on the output terminal 56.

In the case previously explained where N=5, a timing diagram wherein each delay time of the delay lines 12₁˜12₃ is sufficiently large and equivalent from each other is shown in FIG. 7. The switch 52 extracts a specific timeslot portion from each of signal lights S₁ (λ₁), S₂ (λ₂), S ₃ (λ₃), and S₄ (λ₄) shown as reference numerals 60˜66. As obviously from FIG. 3, an output terminal 56 outputs the signal light S₄ (λ₄) first, then S₂ (λ₂), S₃ (λ₃), and S₁ (λ₁) follow in sequence. That is, shown as a reference numeral 68, the signal lights S₄ (λ₄), S₂ (λ₂), S₃ (λ₃), and S₁ (λ₁) are output in this order from the output terminal 56.

By disposing a wavelength converter to convert the optical carrier wavelength of the output signal light from the output terminal 56 into a specific wavelength λₛ, it is possible to convert the signal lights S₁ (λ₁)˜S_{N-1}(λ_{N-1}) having different wavelengths in serial into the signals having the specific wavelength λ_{s.}

Furthermore, when the signal lights S₁ (λ₁)˜S_{N-1}(λ_{N-1}) are applied through different circuits, the signal lights should enter the input terminal 50 after being multiplexed by an arrayed waveguide grating or the like.

(A Fourth Embodiment)

By using the wavelength dependent delay functions of the AWG 10 and the delay line 12, it is possible to convert serially inputting signal lights into signal lights having different wavelength with each other and locating on the same time slot. That is, it is possible to convert a TDM signal light into a WDM signal light. FIG. 8 shows a schematic diagram of such embodiment, and FIG. 9 shows a timing diagram where N=5. The configuration and operation of the part composed of the AWG 10 and the delay line 12 is identical to that of the embodiment shown in FIG. 1.

Signal lights S₁˜S _{N-1} having the same wavelength λₛ enter an input terminal 70 in order. A wavelength converter 72 converts the optical carrier wavelength λₛ of the signal lights S₁˜S_{N-1} into a wavelength different from each other in predetermined order in a range of wavelengths λ₁˜λ_{N-1}. On condition that N=5, the wavelength converter 72 converts the optical carrier wavelength λₛ of the signal lights S₁, S₂, S₃, and S₄ into λ₁, λ₃, λ₂, and λ₄ respectively, shown as a reference numeral 80 in FIG. 9.

As previously explained, the AWG 10 and the delay line 12 delay the signal light of wavelength λ₁, by 3τ, the signal light of wavelength λ₂ by τ, the signal light of wavelength λ₃ by 2τ, and do not delay the signal light of wavelength λ₄. Therefore, shown as reference numerals 82˜88 in FIG. 9, the signal lights S₁ (λ₁) S₂ (λ₃) S₃ (λ₂), and S₄ (λ₄) are output at the same timing.

As described above, in the embodiment shown in FIG. 8, the time-division-multiplexed signals S₁, S₂,S₃,and S₄ can be converted into WDM signals.

Although a wavelength interval of AWG was 100 GHz at first, it is getting smaller as 50 GHz, 25 GHz, and 12.5 GHz with time. When an AWG with a narrower wavelength interval is used as the AWG 10, the input ports and output ports should be properly thinned out (e.g. thinned out of every other or two ports). Needless to say that such configuration is obviously included in the technical range of the subject invention.

As readily understandable from the aforementioned explanation, according to the invention, it is possible to realize a compact optical delay unit having a delay amount according to a wavelength. Also, a range of the delay amount can be set flexibly. By combining with a wavelength converter, a variable optical delay unit can be realized. With a simple configuration, WDM (parallel)-TDM (serial) conversion and TDM (serial)-WDM (parallel) conversion are easily realized.

While the invention has been described with reference to the specific embodiment, it will be apparent to those skilled in the art that various changes and modifications can be made to the specific embodiment without departing from the spirit and scope of the invention as defined in the claims.

1. An optical delay unit comprising:
a periodic wavelength demultiplexer having M (M is a natural number) input ports including a signal input port, M output ports including a signal output port, and periodic input/output characteristics for wavelengths between the M input ports and the M output ports; and
(M−1) optical paths to connect each of the (M−1) output ports in which the signal output port is excluded from the M output ports of the periodic wavelength demultiplexer with any of the (M−1) input ports in which the signal input port is excluded from the M input ports of the periodic wavelength demultiplexer.

2. The unit of claim 1 wherein each of one or more optical paths within the (M−1) optical paths comprises an optical delay.

3. The optical delay unit of claim 1 wherein the (M−1) optical paths comprise an optical path to connect i^{th} (i is an integer of 1≦i≦(M−2)) output port in the M output ports of the periodic wavelength demultiplexer with (i+1)^{th} input port in the M input ports of the periodic wavelength demultiplexer.

4. The unit of claim 1 further comprising a first wavelength converter to convert an optical carrier wavelength of an input signal light into any one of wavelengths capable of being demultiplexed by the periodic wavelength demultiplexer and apply to the signal input port.

5. The unit of claim 4 further comprising a second wavelength converter to convert an optical carrier wavelength of output signal light from the signal output port of the periodic wavelength demultiplexer into a predetermined wavelength.

6. The unit of claim 1 further comprising:
a first wavelength converter to convert an optical carrier of a first input signal light into any one of wavelengths capable of being demultiplexed within a first FSR of the periodic wavelength demultiplexer;
a second wavelength converter to convert an optical carrier of a second input signal light into any one of wavelengths capable of being demultiplexed within a second FSR different from the first FSR of the periodic wavelength demultiplexer;
an optical multiplexer to multiplex output signal lights from the first and second wavelength converters and apply to the signal input port;
an optical demultiplexer to demultiplex output signal lights from the signal output port of the periodic wavelength demultiplexer into signal light belonging to the first FSR and signal lights belonging to the second FSR;
a third wavelength converter to convert the optical carrier wavelength of the signal light belonging to the first FSR demultiplexed by the optical demultiplexer into a first predetermined wavelength; and
a fourth wavelength converter to convert the optical carrier wavelength of the signal light belonging to the second FSR demultiplexed by the optical demultiplexer into a second predetermined wavelength.

7. The unit of claim 1 further comprising an optical switch to which a WDM optical signal inputs, the WDM optical signal being composed of signal lights carried by optical carriers having a wavelength different from each other within a plurality of wavelengths capable of being demultiplexed by the periodic wavelength demultiplexer, the optical switch extracting a predetermined timeslot portion from the WDM optical signal and apply the extracted portion to the signal input port of the periodic wavelength demultiplexer.

8. The unit of claim 7 further comprising a wavelength converter to convert an optical carrier wavelength of the output signal light from the signal output port of the periodic wavelength demultiplexer into a predetermined wavelength.

9. The unit of claim 1 further comprising a wavelength converter to convert each optical carrier wavelength of a plurality of signal lights entered in serial into any one of a plurality of wavelengths capable of being demultiplexed by the periodic wavelength demultiplexer and apply to the signal input port.

10. The unit of claim 1 wherein the periodic wavelength demultiplexer comprises a periodic arrayed waveguide grating.
